(19) United States
(12) Patent Application Publication
(10) Pub. No.: US 2013/0018674 A1
(43) Pub. Date: Jan. 17, 2013

(54) SYSTEM AND METHOD FOR RADIOLOGY WORKFLOW MANAGEMENT AND A TOOL THEREFROM

(71) Applicants: Ricky Bedi, Bangalore (IN); Raghavendra Ramachandra Rao, Bangalore (IN); Raghavendra Kumar Ravinutala, Bangalore (IN); Vijay Pandurangan, Thiruvarur (IN); Karthikeyan Subbaraj, Virudunagar (IN)

(72) Inventors: Ricky Bedi, Bangalore (IN); Raghavendra Ramachandra Rao, Bangalore (IN); Raghavendra Kumar Ravinutala, Bangalore (IN); Vijay Pandurangan, Thiruvarur (IN); Karthikeyan Subbaraj, Virudunagar (IN)

(21) Appl. No.: 13/637,655

(22) PCT Filed: Feb. 15, 2011
(86) PCT No.: PCT/IB11/50621

§ 371 Date: Sep. 27, 2012

(30) Foreign Application Priority Data
Apr. 1, 2010 (IN) 924/CHE/2010

(51) Int. Cl. G06Q 50/24

(52) U.S. Cl. 705/3

(57) ABSTRACT

A method and system for managing radiology study orders is disclosed. The method includes the steps for creating an order for a radiology study; receiving one or more images; reconciling an image from one or more images with the order, based on a reconciliation rule set to obtain the radiology study; assigning a radiologist for the radiology study based on auto-scheduling rule set and control parameters; reading of the radiology study by the radiologist; recording of a radiology report for the radiology study by the radiologist; generating a quality index for the radiologist based on the radiology report; sending the radiology report to a physician; and approving of the radiology report by the physician.

### TECHNICAL FIELD

The invention relates generally to radiology information systems and more particularly to a method and system for managing radiology study orders.

### BACKGROUND

The field of radiology encompasses very broadly a method of organ scanning using several techniques such as Ultrasound Scanning, Computed Tomography (CT), Computerized Axial Tomography (CAT), Positron Emission Tomography (PET), and Magnetic Resonance Imaging (MRI), to diagnose or treat diseases. The process of obtaining images using these techniques may also sometimes be referred to as imaging. Radiology information typically comprises images from a scan conducted by any of the above mentioned techniques, it may also include date and time stamps for the scan and select details about the patient, doctor, hospital that were involved in the scanning procedure.

A Radiology Information System or RIS is a computer based application that deals with storing, manipulation and retrieving of radiology information during the different stages from diagnosis and reporting to inventory control. Using the RIS, patient appointments for inpatients and outpatients can be scheduled when an order is received. Functions for scheduling the various available radiology staff with the allocated time slots can also be handled by the radiology information system. Reports concerning the results of an individual patient, a group of patients or a particular procedure can be generated using the RIS.

Picture Archiving and Communication Systems commonly known as PACS is an electronic image information system which enables images from different scanning techniques to be stored electronically and viewed on computer screens. This enables doctors and other health professionals to access information and compare it with previous images electronically. PACS is a combination of hardware and software dedicated to the short and long term storage, retrieval, management, distribution and presentation of images.

Most of the current RIS applications today include a PACS product. There are also thin stand-alone RIS applications i.e. RIS independent of PACS, that provide study and patient information to the radiologists and assist reading of the reports, with some integration to existing systems in the hospital enterprise. Some of the developments in the RIS domain are described below.

US 2003149598 (A1) illustrates a system and method for assignment, scheduling and notification for better patient management. The method takes into account the availability of a registered clinician to whom a registered patient has been assigned. In case of unavailability of a clinician, the system assigns the task to a next available clinician through a wireless device worn by the responsible physician. However . . . .

U.S. Pat. No. 6,603,494 describes an imaging system coupled to a network wherein the network provides the imaging device with remote services from a remote facility. The interface includes a display and a programmed data processor for providing a uniform interface image. The uniform interface image includes a function navigation space including function icons corresponding to procedures which are common to both the first and second imaging modalities and a workspace adjacent the function navigation space for displaying, analyzing and manipulating images of a type consistent with the specific modality. When an icon is selected, the processor correlates the selected icon with a corresponding command and executes the command. Despite the advantages provided therein, . . . .

US 2006184943 (A1) and U.S. Pat. No. 7,562,026 provide a User Interface System to a physician through a Radiology Information System (RIS) to provide information identifying scheduled procedures, room and equipment availability and clinician availability. A patient tracking unit monitors patient status including progress of patient procedures and patient arrival. An information management processor updates a task schedule of a worker in response to a change in patient status.

U.S. Pat. No. 7,729,928 describes a system for managing remote doctor medical request workflow. The workflow module optimizes assignments of radiological reading requests to remote doctors based on parameterized doctor and scheduling information. It may further include a forecasting module that predicts the hospital credentials, state licenses or doctors needed to fulfill a volume of future medical requests. Incoming requests for review of CT scans and the like are filtered based on the parameterized radiologist information to identify one or more radiologists who are available.

With these developments, there is a continuing need to make the radiology information system still more efficient and user friendly to enable faster diagnosis and reporting that has an impact on patient care.

### BRIEF DESCRIPTION

In one aspect, a method for managing radiology study orders is disclosed. The method includes the steps for creating an order for a radiology study; receiving one or more images; reconciling an image from one or more images with the order, based on a reconciliation rule set to obtain the radiology study; assigning a radiologist for the radiology study based on auto-scheduling rule set and control parameters; reading of the radiology study by the radiologist; recording of a radiology report for the radiology study by the radiologist; generating a quality index for the radiologist based on the radiology report; sending the radiology report to a physician; and approving of the radiology report by the physician.

In another aspect, a radiology workflow management system is disclosed that includes an order server for receiving an order for a radiology study; a communication module to interface with a PACS module to receive one or more images; a reconciliation module to map the order with the one or more images for the radiology study; a workflow module to auto assign the study to an appropriate radiologist based on auto scheduling rule set and control parameters; an application accessible by the appropriate radiologist to view the radiology study, wherein the application comprises a collaboration tool set, a recording module and a reporting module; a quality module to check and provide a quality index for the radiologist based on a report from the reporting module, based on predefined quality parameters; and a clearance engine for generating an approved report after receiving an approval on the report from a physician.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a radiology workflow management system according to one embodiment of the invention; and

FIG. 2 is a flowchart representation for method for providing an integrated radiology study.

### DETAILED DESCRIPTION

As used herein and in the claims, the singular forms “a,” “an,” and “the” include the plural reference unless the context clearly indicates otherwise.

Radiology images as used herein are an output of the radiology or the scanning technique, typically in the form of images and contain a wealth of information, such as anatomy and pathology details for an organ that was scanned. The radiology images may be obtained from several forms of imaging techniques to detect abnormalities within the body. Radiology images are almost always in the DICOM format which embeds the patient demographics (e.g. name, age, gender) and modality information (e.g. scan date, study description etc.) alongside the image pixel data. The image data may also be compressed using a DICOM-compliant algorithm (e.g. J2K Lossless) and the algorithm denotes whether the image data is of diagnosable quality (lossless) or inferior quality (lossy). DICOM images are transferred through an elaborate DICOM handshake between one PACS node and other over the TCP transport protocol

A radiology study as described herein includes the request for reading of the radiology images and the associated radiology images.

A radiologist as used herein is a medical professional who has specialized training in obtaining and interpreting radiology images. A radiologist correlates medical image findings with other examinations and tests, reports the findings, may recommend further examinations or treatments, and may confer with referring physicians (the doctors who send patients to the radiology department or clinic for testing).

A physician as used herein is also generally referred to as a doctor of medicine or simply doctor with an appropriate educational qualification, who is concerned with maintaining or restoring human health through the study, diagnosis, and treatment of disease or injury.

An order server as described herein, in the context of a medical facility or hospital is a server to which radiology read orders are transmitted. The orders may be requests for a doctor to interpret, or read, digitized medical images, such as X-ray images, CAT scans, and MRI's images. Furthermore, orders may contain information, such as a patient identifier, the procedure type associated with the image, patient demographic information, and a hospital identifier.

An electronic medical record (EMR) as referred herein is a medical record for a patient maintained in an electronic format that are generally created in an organization that provides medical services, such as a hospital or a clinic. Electronic medical records tend to be a part of a health information system that allows storage, retrieval and manipulation of records. In some instances, electronic medical records are legal records to be accessed only authorized personnel, such as a qualified medical practitioner. Electronic medical records are maintained in a file format that is suitable for the organization. Electronic medical records for a single patient may be in a single file or multiple files, depending on the level of details needed to be stored, and other considerations. In the case of multiple files used to store electronic medical record for a single patient, each file may have a particular set of data, such as personal details like height, weight, age, gender etc. in one file; medical history in another file; prescription history in yet another file; family medical history in another file; and so on. Each file is typically interlinked to the other through the use of appropriate tags.

DICOM (Digital Imaging and Communications in Medicine) as used herein is a standard for handling, storing, printing, and transmitting information in medical imaging. It includes a file format definition and a network communications protocol for transmission of radiological images and other medical information between computers. DICOM enables digital communication between diagnostic and therapeutic equipment and systems from various manufacturers. DICOM users can provide radiology services within facilities and across geographic regions, gain maximum benefit from existing resources, and keep costs down through compatibility of new equipment and systems. For example, workstations, CT scanners, MR imagers, film digitizers, shared archives, laser printers, and host computers and mainframes made by multiple vendors and located at one site or many sites can “talk to one another” by means of DICOM across an “open-system” network. As a result, medical images can be captured and communicated more quickly, physicians can make diagnoses sooner, and treatment decisions can be made sooner.

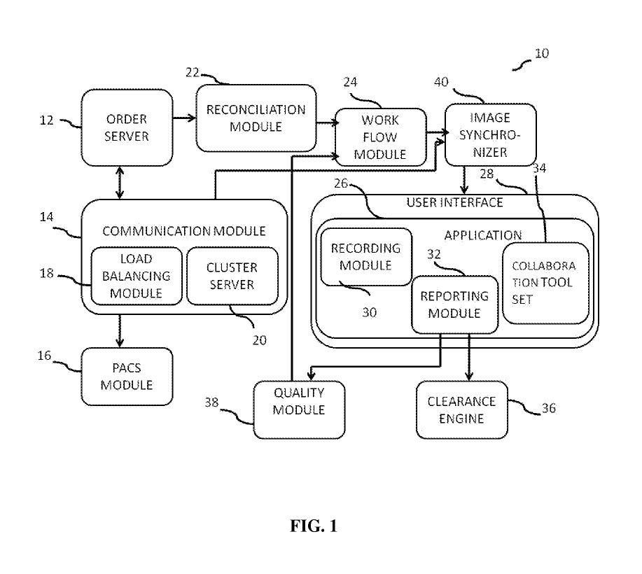

Now turning to drawings, according to one aspect a radiology workflow management system 10 is disclosed that provides an integrated radiology study system that integrates the different components and resources needed for receiving and interpreting a radiology study, and for dispatching a report on the radiology study in a reproducible and timely manner. As shown in FIG. 1, the system 10 includes an order server 12 for receiving an order for a radiology study. The system 10 also includes a communication module 14 to interface with a PACS module 16 to receive one or more images. The communication module 14 in an exemplary embodiment includes a load balancing module 18 to form a distributed cluster of images received from the PACS module 16. In the exemplary embodiment DICOM load balancing is done in order to receive the images from an external PACS node in a parallel manner to avoid queuing of images, which is a problem seen in the prior art radiology information systems. The load balancing module ensures that the images received are distributed across the cluster server 20 (a group of servers) optimally thereby increasing the overall throughput of the communication module

A reconciliation module 22 is used for reconciling or mapping an order from the order server 12 with the corresponding one or more images received from the PACS module 16 for the radiology study. A reconciliation rule set is used by the reconciliation module for this purpose and to obtain the radiology study. Reconciliation may be done by using overlap information in the order and in the images. The reconciliation module identifies basic information that may be missing for the radiology study. For example, the reconciliation module may identify, missing images if the images received do not match the number of images stated in the order. Similarly missing information related to patient name, contact information, referring physician etc. may be identified for the reconciliation module. Orders with such missing information are highlighted for further action.

The system 10 further includes a workflow module 24 to auto assign the radiology study to an appropriate radiologist based on assignment rule set and control parameters. It may be appreciated by those skilled in the art that the rule set may be pre-defined but may be updated periodically to ensure the rules address the availability of radiologists and other parameters, such as hardware requirements, connectivity issues and the like. The auto-scheduling rule set in an exemplary embodiment comprises rules for radiologist credentiality, bandwidth rules, dynamic calendars for one or more radiologists, re-assignment rules. Radiologist credentiality herein includes information related to State license, which license is required to practice in a given State; Hospital license, which license is required to practice with a given hospital; etc granted to the radiologist. Bandwidth rules as used herein include the information related to local bandwidth availability for assignment of the radiology study. This is useful in order to decide the location for assigning the radiology study. Bandwidth rules also includes identifying if the radiologist in on a secure network or an unsecure network, and accordingly take appropriate action. It may be appreciated by those skilled in the art that the radiology workflow will be optimized if the radiologist that can accept the radiology study based on his credentiality and other parameters, the hospital, the physician are available within the same location from bandwidth consideration. Dynamic calendars for the radiologists as referred herein imply the availability of a dynamic status for the radiologist engagements and appointments that is useful for scheduling and assigning the radiology study based on such calendar information. This ensures that at no time the workflow module does a blind assignment for any radiologist. Re-assignment rules as mentioned herein would include rules for re-assigning the radiology study to another radiologist if the first radiologist has not been able to complete the reading and reporting needed for the radiology study in a stipulated time-period.

The control parameters used in the exemplary embodiment include identity of the radiology study, number of images, radiologist specific control parameters for number of radiology studies assigned, time-out for a radiology study, service level agreement, and the like. Identity of the radiology study as referred herein implies whether the radiology study is a primary study or a secondary study. As would be appreciated by those skilled in the art, the primary study can be assigned to a junior level radiologist, whereas the secondary study would be assigned to a senior level radiologist. It must also be noted by those skilled in the art, that for the sake of simplicity of description, primary and secondary studies have been used herein, however more levels may be provided to distinguish the radiology study based on complexity of the study. Number of images as referred herein implies number of images in each radiology study. It may be appreciated by those skilled in the art that based on the disease or scanning modality, number of images for each radiology study would be different and accordingly the assignment must take into account the number of images. Time-out as used herein implies an instance of time that marks an elapse of a period of time that was pre-defined for providing a report for the assigned radiology study, and such a radiology report has not been submitted in this time-period. The re-assignment rules as described herein above will kick-in in the event of a time-out. Service level agreement as referred herein implies, the service agreement or contract of the radiologist with a particular hospital or an establishment implementing the radiology workflow management system 10.

In one exemplary embodiment the following rules are used for assigning the radiology study:

IF study originates from HOSP1 AND
IF study's modality is CT AND
IF study arrives after 11 AM AND
THEN assign to radiologist WHO
is in shift AND
is available for next 1 hour AND is credentialed for HOSP1 AND
is specialized in CT AND
has the least average TAT (turn-around-time)

The system 10 further includes an application 26 that is accessible by the appropriate radiologist to view the radiology study through a suitable user interface 28 such as but not limited to a graphical user interface like a computer monitor or a screen of a mobile communicating device like a mobile phone.

The application advantageously includes, a recording module 30 and a reporting module 32, and a collaboration tool set 34. In one exemplary embodiment, the recording module 30 includes voice recording for machine or human transcription. In another example, the recording module enables a dynamic remote transcription support for recording the report by the radiologist. The transciptor is selectable on the fly based on availability of such a resource. This ensures that the resources needed for transcription are optimized and are available on as per the need basis. Also by enabling such transcription through a communication interface, the transciptors may be selected from different geographies adding to the dynamic nature of this feature.

The reporting module 32 enables generation of a radiology report based on the analysis of the radiologist. Radiology report may be generated in a desired pre-defined format, using a standardized template. In one example, the reporting module 32 allows for electronic generation of the report and provides for the source identity for radiology report to indicate an author for a content in the radiology report. The source identity may be provided through color coding or author balloons or any other suitable means. As is described below, the radiology report may include inputs from one or more radiologists and it is useful to know the source of the inputs for future reference and for quality assurance purpose, hence the source identity feature facilitates such requirements. Further the reporting module 32 may also be configured to incorporate the EMR in the report or alternately update an EMR with the contents of report.

The collaborative tool set 34 allows a context based collaborating exercise with at least a second radiologist after the reading of the radiology study. It may be appreciated by those skilled in the art that the context based collaborating exercise may be done online using at least one of email, voice chat, electronic messaging. Any notes from the context based collaborative exercise are attached to the report generated by the reporting module 32. In the exemplary embodiment, the collaborative tool set 34 provides a dynamic list of one or more context based collaborators on a user interface viewable by the radiologist. The dynamic list may be available to the radiologist as a drop down menu or similar representation. The collaborative tool set 34 also communicates the radiology study to the one or more context based collaborators in the dynamic list. Once a request for context based collaborative exercise is initiated by the assigned radiologist, by selecting one or more context based collaborators, the request may be accepted by one or more context based collaborators in the dynamic list. The context based collaborating exercise is then done online using at least one of email, voice chat, electronic messaging, or through other medium such as phone or face-to-face interaction, and the inputs from the context based collaborative exercise are captured as notes for the radiology study. Such notes are attached in the radiology report.

The system 10 further includes a clearance engine 36 for generating an approved tag for the radiology report from a physician. As it would be appreciated by those skilled in the art, each of the radiology reports require a physician approval before it can be handed over to a patient. The system 10 allows for electronic approval and signature process.

The system 10 advantageously includes a quality module 38 to check and provide a quality index for the radiologist based on predefined quality parameters for the radiology reports. The quality index is in turn used by the workflow module 24 for selecting an appropriate radiologist for new radiology studies. In order to generate the quality index, each radiology report completed by the radiologist is evaluated on pre-defined quality parameters, and a score is assigned for each radiology report based on the evaluation. For each radiologist, the scores for the radiology reports completed by them over a defined period of time are compiled. Such compiled scores are used to generate quality indicies using standard mathematical techniques known to those of ordinary skill in the art. Such techniques include, for example, averaging, weighted averaging, addition, calculating the median, root-mean-square average, weighted average with a standard deviation, and the like. The compiled scores are used to further assign at least a generic quality index and a specific quality index for the radiologist. A combination of the generic quality index and the specific quality index form the quality index for the radiologist. The generic quality index is a compilation of scores from all of the parameters used to evaluate a radiologist, and is useful to assess an overall performance of the radiologist, and may provide further insights as to the working rhythm, patterns etc. The specific quality index is generated from a specific set of parameters used to evaluate a radiologist. The quality parameters used for scoring the radiology reports include a modality indication, a procedure indication, a time of delivery of the radiology report, a turn-around time for the radiology report. The generic quality index and the specific quality index are used by the work flow module for assignment of new radiology study to the radiologist. The quality indices as described herein provide crucial information related to the output from the radiologist so that the strength areas as well as development needs for the radiologist are identified and informed and intelligent decisions can be made by the work-flow module.

In one exemplary embodiment, radiology reports are randomly picked across multiple types and modalities of radiology studies assigned to a particular radiologist. These studies are assigned among the designated radiologists for peer review. The designated radiologists review the radiologists' reports and score it on the following parameters:

(i) Concurrence with interpretation
(ii) Discrepancy in Interpretation/not ordinarily expected to be made (understandable miss)
a. Unlikely to be significant
b. Likely to be significant
(iii). Discrepancy in Interpretation/should be made most of time
a. Unlikely to be significant
b. Likely to be significant
(iv). Discrepancy in Interpretation/should be made almost every time—misinterpretation of findings
a. Unlikely to be significant
b. Likely to be significant
The scores are compiled for the above parameters and a distribution plotted for the radiologist for the following:

significant and insignificant findings,

stroke and electives

across modalities

across different study times

across locations

for different turnaround times

primary read/secondary read

In one example, an average score is calculated dynamically for each or a combination of the above parameters. These scores (averaged or individual) are further used to indicate a specific and a generic quality index for the radiologists.
Further in another exemplary embodiment, the quality indicies may be used for one or more of the following actions:
Training: The trainings for the radiologists are allocated based on the weak score study types & modalities, improving overall performance in such studies. This will have a high impact on the overall quality improvement.
Assignment: The study is assigned to the radiologist based on the dynamically calculated quality index for the combination of study type, time of study, turn around time, modality and procedure type. The workflow module assigns the radiology study to the radiologist with the best score among those who satisfy the other filter criterion for the radiologist assignment for that particular study.
Pay Per Performance: A finance module can be used to calculate the pay per report payments of the radiologist, takes the rules based on scoring of his reports to determine his payment. The organization using the system 10 can set the incentive/penalty rules based on the scoring.
Hiring Decisions: The system 10 analyses the various data within the system to provide trends for making effective management decisions including that of hiring. The system 10 provides the average scores across different specialties, different geographies, shifts. This will give the trend for the management to make a hiring decision on the specialty of the radiologist hire, the time shift to hire the radiologist on or the location

The system 10 also includes a rule-based image synchronizer 40 for image synchronizing for the radiology study using a rule-based file synchronizer for optimizing reading and reporting for the radiology study. Rules can be specified such that when an image is received by the system, the image is synchronized with one or more PACS nodes within the system (without using the DICOM protocol). Alternatively, the workflow module can also initiate this activity. Synchronization ensures that the images are available in a location very close to the reading radiologist.

It may be appreciated by those skilled in the art that the entire system 10 may be provided as a web-enabled application, or select modules may be web-enabled and others may be a provided as dedicated hosted applications. One skilled in the art will also appreciate having multiple levels of access to the system 10, wherein each level of access gives different levels of control and/or access for the system 10. Different levels of access include, but not limited to, Radiologist, Physician, Manager, Administrator, Owner, and the like. Further levels of access such as Trainees, and the like may become obvious to one skilled in the art. Access to the system 10 may be made through a login dialog, which comprises a username and a password. Alternately, login can be made available for a given internet protocol address (also sometimes referred to in the art as IP address).

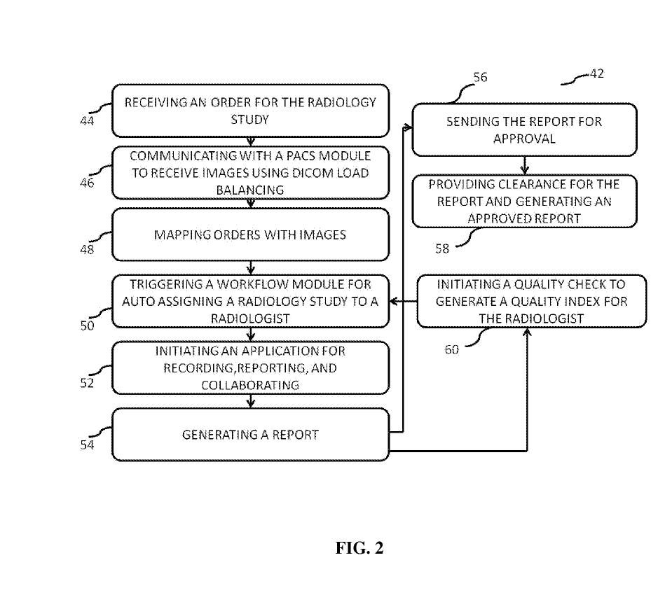

The method for providing an integrated radiology study, using the system 10 is illustrated in FIG. 2 by flowchart 42. The method includes a step 44 of receiving an order for a radiology study and a step 46 for communicating with a PACS module to receive one or more images. The method includes a step 48 for mapping the order with the one or more images for the radiology study. The method then at step 50 triggers a workflow module as described herein to auto assign the study to an appropriate radiologist based on assignment rules set. Next the method includes at step 52 initiating an application accessible by the appropriate radiologist to view the radiology study, wherein the application comprises a collaboration tool set, a recording module and a reporting module. A report is generated at step 54 that includes the interpretations of the radiologist. At step 56 a quality check is initiated to check the report based on predefined quality parameters. At step 58 a quality tagged report is generated, the generic and specific quality indices are generated for the radiologist and communicated to the work flow module. At step 60 the report is communicated to a physician for approval. At step 62 a clearance step is initiated for generating an approved report.

The step 46 may further comprising a sub-step that includes load balancing for the one or more images to form a distributed cluster for each image through a load balancing engine, and a cluster server may be provided to handle the distributed cluster. It may further include a sub-step for providing a rule-based image synchronizer for synchronizing a file system to organize the images for the radiology study. It may be noted here that a single study can be processed across many servers in the cluster and later regrouped back to one.

It may be appreciated by one skilled in the art that the method and process steps and algorithms described herein can be executed by means of software running on a suitable processor, or by any suitable combination of hardware and software. When software is used, the software can be accessed by a processor using any suitable reader device which can read the medium on which the software is stored. The computer readable storage medium can include, for example, magnetic storage media such as magnetic disc or magnetic tape; optical storage media such as optical disc, optical tape, or machine readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application. Similarly a communication link that may be an ordinary link or a dedicated communication link may be provided for accessing the radiology workflow management system from a user's work station.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A method for managing radiology study orders, the method comprising:
creating an order for a radiology study;
receiving one or more images;
reconciling an image from one or more images with the order, based on a reconciliation rule set to obtain the radiology study;
assigning a radiologist for the radiology study based on auto-scheduling rule set and control parameters;
reading of the radiology study by the radiologist;
recording of a radiology report for the radiology study by the radiologist;
generating a quality index for the radiologist based on the radiology report;
sending the radiology report to a physician;
approving of the radiology report by the physician.

2. The method of claim 1 wherein assigning further comprises using the quality index for an assignment for the radiology study.

3. The method of claim 1 wherein generating the quality index for each radiologist comprises:
evaluating each radiology report completed by the radiologist on a plurality of quality parameters;
assigning a score for each radiology report based on the evaluation;
compiling scores of a plurality of radiology reports completed by the radiologist over a defined period of time; and
assigning at least a generic quality index and a specific quality index for the radiologist based on the scores, wherein a combination of the generic quality index and the specific quality index form the quality index for the radiologist.

4. The method of claim 3 wherein the plurality of quality parameters comprise a modality indication, a procedure indication, a time of delivery of the radiology report, a turn-around time for the radiology report.

5. The method of claim 1 further comprising initiating a context based collaborating exercise with at least a second radiologist.

6. The method of claim 5 wherein the context based collaborating exercise comprises:
providing a dynamic list of one or more context based collaborators on a user interface viewable by the radiologist;
providing the radiology study to the one or more context based collaborators;
initiating a request for context based collaborative exercise by selecting one or more context based collaborators by the radiologist;
accepting the request by the one or more context based collaborators; and
capturing inputs from the context based collaborative exercise as notes for the radiology study.

7. The method of claim 6 further comprising attaching notes from the collaborating exercise to the radiology study.

8. The method of claim 5 wherein the context based collaborating exercise is done online using at least one of email, voice chat, electronic messaging, telephony conversation.

9. The method of claim 1 wherein the auto-scheduling rule set comprises rules for radiologist credentiality, bandwidth rules, dynamic calendars for one or more radiologists, re-assignment rules.

10. The method of claim 1 wherein the control parameters comprise identity of the radiology study, number of images, radiologist specific control parameters for number of radiology studies assigned, time-out for a radiology study, service level agreement.

11. The method of claim 1 wherein the recording is done using a dynamic remote transcription support.

12. The method of claim 1 wherein the radiology report comprises source identity for an author for a content in the radiology report.

13. The method of claim 1 further comprising dynamic load balancing for receiving one or more sub-images forming a distributed cluster for each image.

14. The method of claim 13 further comprising providing a server to handle the distributed cluster.

15. The method of claim 1 further comprising image synchronizing for the radiology study using a rule-based file synchronizer for optimizing reading and reporting for the radiology study.

16. The method of claim 1 further providing a user interface for reading the radiology study, for context based collaborating and for providing the radiology report.

17. The method of claim 16 wherein the user interface is an electronic platform comprising a graphical user interface or a mobile phone user interface.

18. A method for providing an integrated radiology study, the method comprising:
receiving an order for a radiology study;
communicating with a PACS module to receive one or more images;
using a reconciliation module to map the order with the one or more images for the radiology study;
triggering a workflow module to auto assign the study to an appropriate radiologist based on auto scheduling rule set and control parameters;
initiating an application accessible by the appropriate radiologist to view the radiology study, wherein the application comprises a collaboration tool set, a recording module and a reporting module;
generating a report for the radiology study in the reporting module;
initiating a quality module to check the report based on predefined quality parameters;
generating a quality index for the radiologist from the quality module;
using the quality index for assigning a new radiology study by the work flow module;
sending the report to a physician for approval; and
initiating a clearance engine for generating an approved report.

19. The method of claim 18 wherein the collaborative tool set allows a context based collaborating exercise with at least a second.

20. The method of claim 19 wherein the context based collaborating exercise is done online using at least one of email, voice chat, electronic messaging.

21. The method of claim 19 further comprising attaching notes from the context based collaborating exercise to the report for the radiology study.

22. The method of claim 18 further comprising load balancing using a DICOM load balancer to form a distributed cluster images.

23. The method of claim 22 further comprising providing a cluster server to handle the distributed cluster.

24. The method of claim 19 further comprising image synchronizing for the radiology study using a rule-based file synchronizer for monitoring a file system for the radiology study.

25. A radiology workflow management system comprising:
an order server for receiving an order for a radiology study;
a communication module to interface with a PACS module to receive one or more images;
a reconciliation module to map the order with the one or more images for the radiology study;
a workflow module to auto assign the study to an appropriate radiologist based on auto scheduling rule set and control parameters;
an application accessible by the appropriate radiologist to view the radiology study, wherein the application comprises a collaboration tool set, a recording module and a reporting module;
a quality module to check and provide a quality index for the radiologist based on a report from the reporting module, based on predefined quality parameters; and
a clearance engine for generating an approved report after receiving an approval on the report from a physician.

26. The system of claim 25 further comprising a load balancing module to de-cluster the one or more images forming a distributed cluster for each image.

27. The system of claim 26 further comprising a cluster server to handle the distributed cluster.

28. The system of claim 25 further comprising a rule-based image synchronizer for monitoring a file system for the radiology study.

29. A method for generating a quality index for a radiologist, wherein the method comprises:
evaluating a radiology report completed by the radiologist on a plurality of quality parameters;
assigning a score for the radiology report based on the evaluation;
compiling the score for each radiology report completed by the radiologist over a defined period of time to provide compiled scores; and
assigning at least a generic quality index and a specific quality index for the radiologist based on the complied scores, wherein a combination of the generic quality index and the specific quality index form the quality index for the radiologist.

30. The method of claim 29 wherein the plurality of quality parameters comprise a modality indication, a procedure indication, a time of delivery of the radiology report, a turn-around time for the radiology report.
